(19) United States
(12) Patent Application Publication
(10) Pub. No.: US 2015/0221995 A1
(43) Pub. Date: Aug. 6, 2015

(54) Pouch-Type Battery Cell With Integrated Cooling Features

(71) Applicant: Ford Global Technologies, LLC, Dearborn, MI (US)

(72) Inventors: Brian Joseph Robert, Saint Clair Shores, MI (US); Thomas J. Coupar, Ann Arbor, MI (US)

(73) Assignee: Ford Global Technologies, LLC, Dearborn, MI (US)

(21) Appl. No.: 14/173,463

(22) Filed: Feb. 5, 2014

(51) Int. Cl. H01M 10/625; H01M 10/647; H01M 10/6555; H01M 10/6551

(52) U.S. Cl. CPC H01M 10/5016; H01M 10/5046; H01M 10/5032; H01M 10/5055

(57) ABSTRACT

A pouch-type battery cell includes a cell electrode having a cell side and a thermally conductive pouch contacting the cell side. The thermally conductive pouch includes a metal layer having a plurality of topographic features, and the features are configured to increase the effective surface area of the pouch. A cover arrangement is included to direct coolant over the pouch.

### TECHNICAL FIELD

The present disclosure relates to a pouch-type battery cell with integrated cooling features.

### BACKGROUND

The emergence and utilization of pouch-type Li-ion cells in energy storage applications presents a new paradigm in battery pack system engineering, especially in the design of the device for thermal management. Service life of a pouch-type battery can be shortened due to swelling of the pouch used to encapsulate the active region of the cell. High humidity and high temperature degrades the active region of the cell. Control of the temperature of the battery cell may be important for cell longevity.

### SUMMARY

In one embodiment, a pouch-type battery cell includes a cell electrode having a cell side and a thermally conductive pouch contacting the cell side. The thermally conductive pouch includes a metal layer having a plurality of topographic features and the features are configured to increase the effective surface area of the pouch. A cover arrangement is included to direct coolant over the pouch.

In another embodiment, a pouch-type battery cell is provided with at least one cell electrode having a cell side that includes a plurality of topographic features formed thereon. The features are configured to increase an effective surface area of the cell side. A thermally conductive pouch is embossed onto the topographic features of the cell electrode. A cover arrangement is included to direct coolant over the topographic features.

In still another embodiment, a vehicle comprising a traction battery including a plurality of pouch-type cells stacked to form an array is provided. Each of the cells includes a thermally conductive pouch having a plurality of topographic features that are configured to increase the effective surface area of the cell. A cooling arrangement is interleaved with the cells and configured to direct coolant over the topographic features to cool the battery.

### BRIEF DESCRIPTION OF THE DRAWINGS

FIG. 1 is a fragmented cross-sectional view of a pouch-type battery cell in which the cooling features are in the pouch structural material;

FIG. 2 is a fragmented cross-sectional view of a pouch-type cell in which the cooling features are in the outermost cell electrode;

FIG. 3 is a schematic illustration of the surface of a pouch-type cell and the cooling manifold;

FIG. 4 is a perspective view of the surface of a pouch-type cell with raised cooling features that extend linearly across the pouch;

FIG. 5 is a perspective view of a refinement of the surface of a pouch-type cell in which the features are wavy;

FIG. 6 is a perspective view of an additional refinement of the surface of a pouch-type cell in which the features are discrete regions;

FIG. 7A is a perspective view of the surface of a pouch-type cell in which the features on the pouch-type cell form arcs;

FIG. 7B is a perspective view of the surface of a pouch-type cell in which the features form arcs and are grouped with a flow channel between the groups;

FIG. 8 illustrates multiple battery cells with a pouch cell;

FIG. 9 is a schematic of the method of making the pouch-type cell with integrated features; and

FIG. 10 is a schematic of a vehicle using a traction battery cooled with the pouch features.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The current state of the art thermal management for pouch-type cell uses additional hardware, such as plastic fixtures, cold plates, and compression mounts to help regulate cell temperatures and battery array structure temperature. These designs increase system complexity, cost, weight and yield. The need exists for a simplified system structure with reduced part count and to improve production assembly process speeds. The reduced part count decreases the potential failures that can occur, as does limiting the number of connections and interfaces to the thermal system. As the pouch-type battery cell technology matures and improves, there is ample opportunity to integrate production of cells with cooling features on the cell itself, within the existing structure. There remains a need for simplified cooling for pouch-type battery cells and embodiments of the present invention address this problem by providing integrated surface topographies on existing pouch cell components. Integrating the cooling into existing components reduces part counts, improves manufacturing yield and reduces complexity. It eliminates the need for a cold plate component and associated failure modes. The integrated surface topographies can be designed as cooling path features to enhance thermal heat transfer and cooling. A cooling manifold provides coolant to the features on the pouch which directly cools the pouch cell and its battery cell components. The features can be on one or both sides of the pouch cell, thus enabling designs for single or dual sided cooling. The features are initially fabricated into the surface of the outer electrode of the battery cell or fabricated within the structural component of the pouch itself. The feature is transferred to the thin outer polymer of the pouch during assembly of the pouch. Coolant fluid flows in direct contact with the pouch without penetration into the electrically active regions of the cell. Such integrated cooling features enable direct cooling of the pouch cell surface and eliminate the need for a cold plate component.

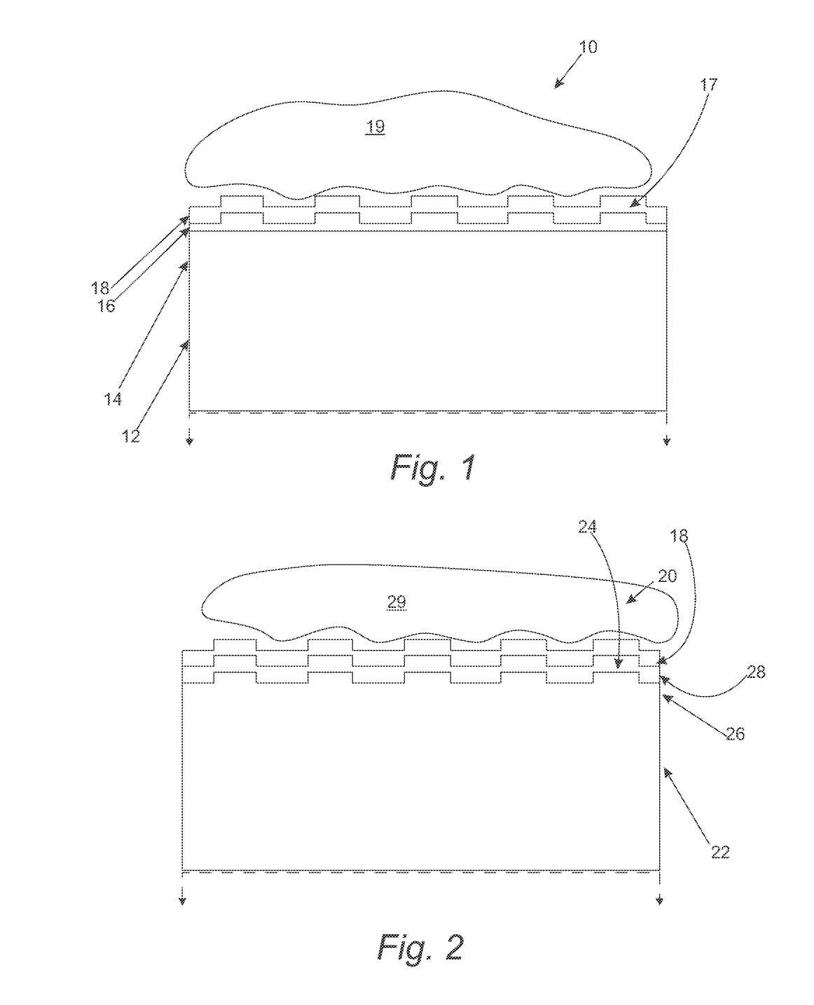

In a first embodiment, the cooling path features are located within the pouch by modification to the structural component employed as pouch cell enclosure material. This is done by preforming the topographic features onto the structural element of the pouch enclosure, such as by stamping or embossing. The structural component of the pouch may be a metal such as aluminum, or other thermally conductive moisture sealing material. The featured pouch structural component is covered by thin polymer layers on each side. Referring now to FIG. 1, a cross-section of a pouch-type battery cell 10 is shown in which the cell electrode structure 12 is covered by an inner polymer layer 14 with an overlying pouch structural material 16 and an outer polymer layer 18. Here the features 17 are formed within the pouch structural material 16. The depth of the features range from 50 mm to 100 mm. The outer polymer material 18 is typically 25-30 microns in thickness and hence conforms to the features 17 within the structural component of the pouch. The coolant 19 is in direct contact with the thin outer polymer layer 18 allowing effective thermal transport to the metal pouch layer for cooling.

Integrating the features into an external pouch case provides an opportunity to integrate the topographic features during processing of a laminated polymer/aluminum/polymer pouch case. The aluminum layer is modified by a technique such as stamping, embossing or etching prior to polymer deposition. The aluminum materials in a typical pouch-type cell can be 40-50 microns thick. Some changes to pre- and post-processed thickness of the aluminum layer may be necessary in this embodiment. Additionally, metals other than aluminum may be used as a structural pouch material such as stainless steel or copper or reinforced materials that can be formed into flexible sheets.

In another embodiment, one or both of the outer-most electrodes within the cell itself have topographic features. The topographic features are resolved upon the surface of the pouch-type cell once the pouch enclosure material is vacuum sealed to enclose the active cell components. FIG. 2 is a cross-sectional view of the pouch-type cell 20 with the cooling features in the cell electrode 22. An outer most electrode 22 has the topographic feature 24 that is embossed into the inner polymer layer 26, the aluminum structural layer 28 and the outer polymer layer 18. The intended features can be resolved through the pouch case materials after the vacuum sealing phase of cell fabrication. The coolant 29 is in direct contact with the outer polymer layer. This embodiment will likely necessitate increasing the thickness of the outer electrode layer or layers that have the topographic features, either the front outer electrode or the back outer electrode or both. Typically the thickness of the electrode material may be increased to 20 mm more than the depth of the features.

An advantage may be that direct cooling on the surface of the pouch cell reduces the thermal resistance of heat dissipation paths from the coolant to the active cell region that is internal to the battery cell. This enhances the local heat transfer coefficient and more effectively cools the cell. Another advantage may be that by integrating cooling features directly to individual cells, the traditional cold plate components for cell thermal management are eliminated. This simplified thermal management design, utilizing existing components, allows for pack and system level designs that are simple to assemble. The number of potential failures is not increased due to additional components and assembly process steps.

Certain embodiments exploit the results of water intrusion studies showing that a high quality seal and encapsulation of the active cell materials prevent coolant penetration into the cell. Additional surface treatment, however, may be employed to ensure the required performance. Surface treatments to further limit moisture ingress could include a wax or other coating to create a hydrophobic layer. This wax, or coating or treatment would cover the cooling features in a thin layer such that the thermal conduction of heat is not compromised.

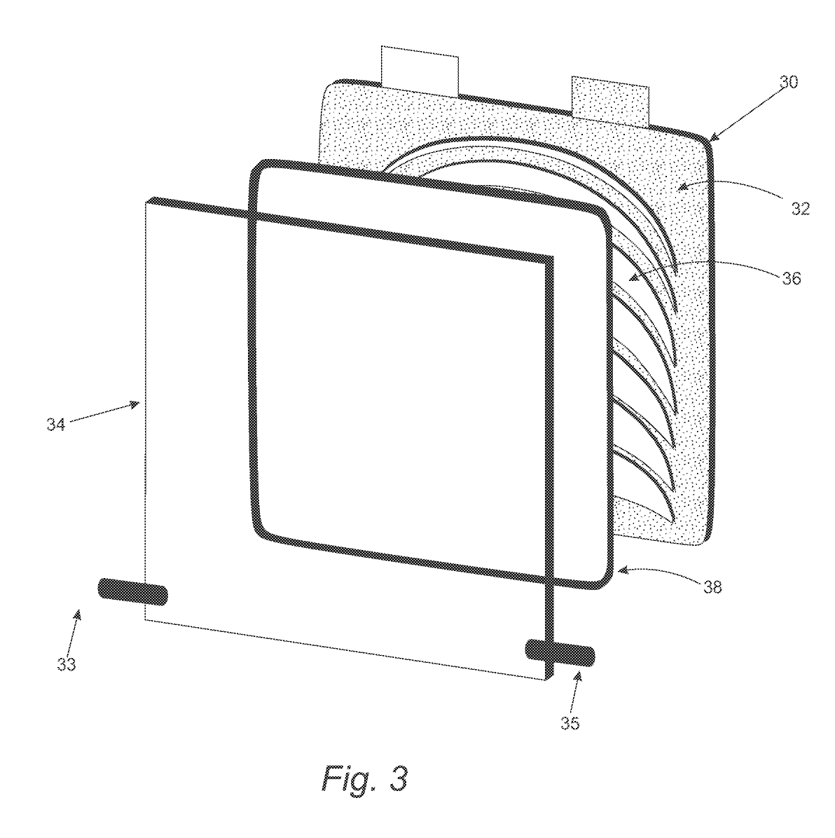

Referring now to FIG. 3, the fabricated and sealed pouch cell with the integrated features is in direct contact with at least one cell electrode 30. The cooling manifold has a cover 34 with a fluid inlet port 33 and a fluid exit port 35 for coolant fluid that extends over the pouch 32 and the pouch features 36. A gasket or seal 38 is used between the pouch 32 and the cooling manifold cover 34 and is recessed in a gasket groove. It is recessed such that the cover touches the features and allows coolant flow only between the features. Furthermore, the seal or gasket ensures isolation of the cooling fluid within the cooling manifold. The coolant can be a liquid such as ethanol, ethylene glycol, deionized water, purified water, or combinations of these liquids; or it can be air or other gases such as nitrogen, argon and inert gases. Alternative designs for the cooling manifold can be used to supply coolant to the features of the pouch-type cell. Submersion of the pouch-type cell in a coolant is an alternative cooling design and necessitates the use of a dielectric cooling fluid.

Direct cooling of the active cells within the array is contained via the pouch surface with integrated features 36, a cover 34 and a gasket or seal 38 creating a coolant manifold 31. The cover 34, in addition to providing an enclosure to hold the cooling fluid in contact with the features 36, additionally serves to align the cells. An array of cells is stacked, located side-by-side, or other orientations, and needs to be aligned, for example in height, side-by-side or with the electrode tabs, etc. The cooling manifold cover accomplishes this alignment since the cell is mated to the manifold wall. Further, the array of cells is compressed by integrating an interlock clip from the cooling manifold cover to a next cooling manifold cover, repeating depending on the number of cells in electrical communication. End plate compression techniques can be employed at the farther ends of the array to further homogenize cell-to-manifold surface mating.

Certain embodiments may allow for a variety of integrated cooling feature designs based upon performance targets and design boundary conditions. The cell features establish a path of cooling fluid through the cooling manifold resulting in a pressure drop across each unit based on feature design and complexity. Multiple cells, each with cooling manifolds, may be arranged in an array. Multiple arrays, or modules, make up a battery pack. An array of cells may consist of individual cooling manifolds with inlet and outlet ports connected to establish a coolant loop.

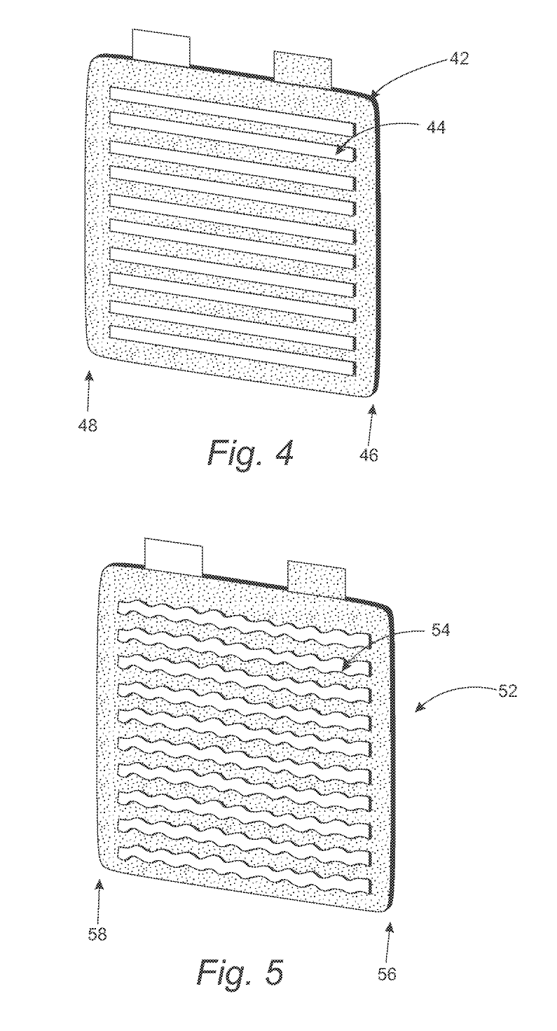

In one embodiment, the geometry of the features is chosen so that the coolant flow is moved across the cell from side to side by linear features, as shown in FIG. 4. FIG. 4 is a perspective view of the surface of the pouch-type cell 42 with raised features 44 that extend linearly from a first side 46 to a second side 48. The features may be aligned so as to direct the cooling fluid flow from the fluid inlet 33 to fluid outlet 35 shown in FIG. 3.

A refinement of this embodiment is shown in FIG. 5. The features 54 on the surface of the pouch-type cell 52 are wavy and extend from a first side 56 to a second side 58. This refinement provides increased surface area and fluid path length for greater thermal conduction and cooling.

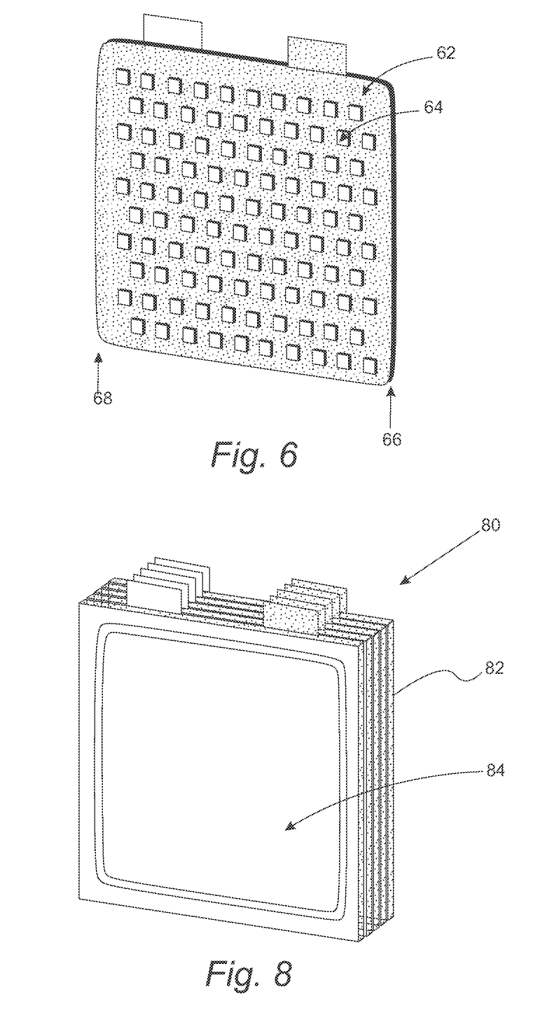

FIG. 6 is a perspective view of an additional refinement of the features on the surface of a pouch-type cell. The features 64 on the surface of the pouch-type cell 62 are discrete regions that do not extend across the pouch. This refinement further increases the path of the cooling fluid by offering an alternative path from the inlet side of the cell 66 to the outlet side of the cell 68.

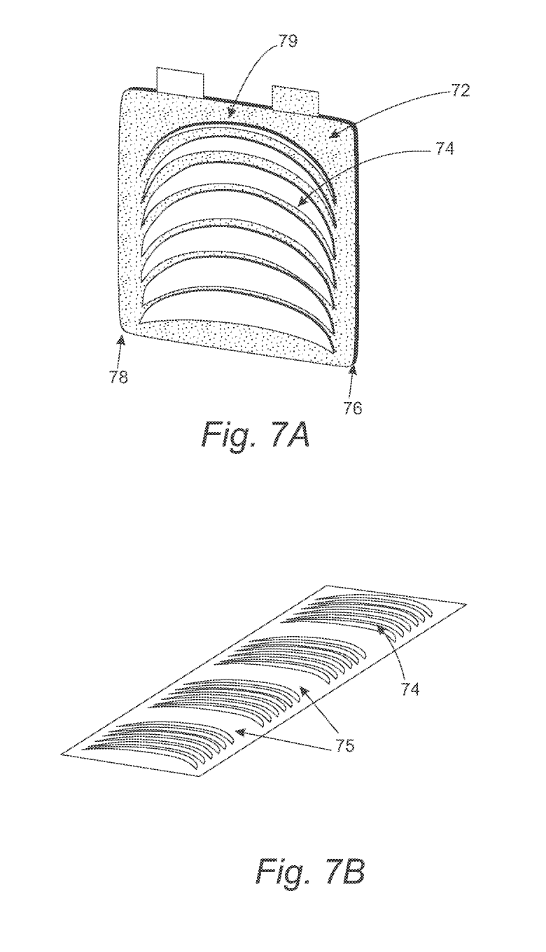

In a further refinement, FIG. 7A is a perspective view of the surface of a pouch-type cell in which the features 74 on the pouch-type cell 72 are arced upward as they extend from the side 76 to the other side 78. The cooling manifold would be arranged for the fluid inlet ports 33 and 35 to be on the lower portion of cell 72 so that the cooling flow is upward and the arc shape of the features 74 provides enhanced cooling to the top of the pouch cell 79. FIG. 7B illustrates yet another refinement in which the arced features 74 are grouped with a flow channel 75 between the groups.

FIG. 8 illustrates multiple battery cells 82 in an array 80. Individual cooling manifolds 84 each make direct contact with features on each cell pouch. The cells can have either one side with features, or both sides with features. There is a wide range of series and parallel combinations of cells in an array.

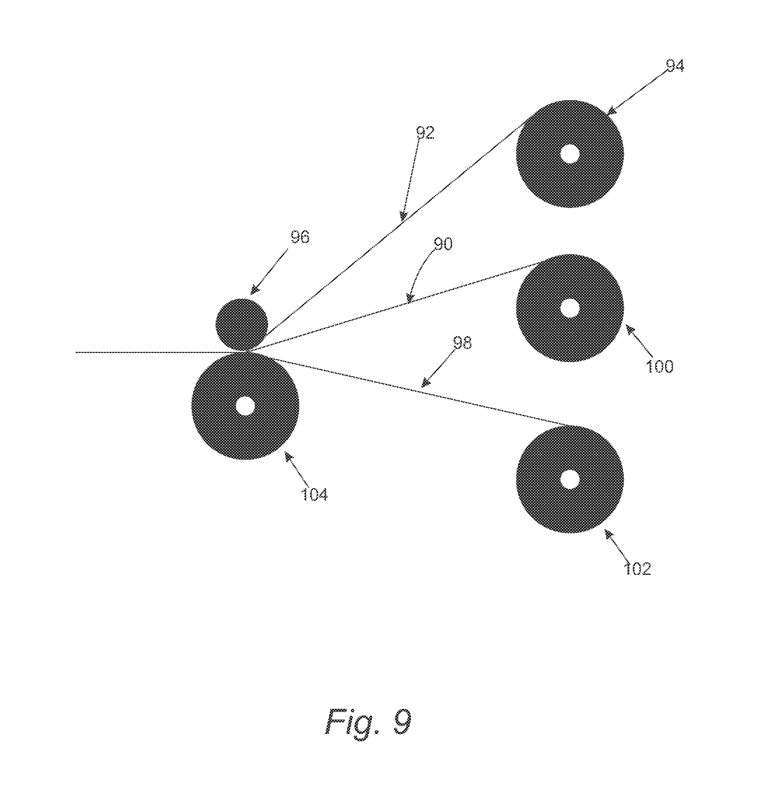

A method of forming the pouch-type cell in which the integrated cooling features are within the structural component of the pouch is shown in FIG. 9. The feature pattern is preformed into aluminum sheet 90 prior to the lamination process. The outer polymer material 92 is provided wound onto a spool 94 and the inner polymer material 98 is provided wound onto a spool 102. The aluminum sheet 90 is preformed into the desired feature pattern and provided on spool 100. The outer polymer material 92 is fed from the spool 94 to a compression roller 96 along with the preformed patterned aluminum sheet 90 and the inner polymer 98. The outer polymer 92, the patterned aluminum 90 and the inner polymer 98 are laminated together by a tension compression roller 104 that does not, or does not substantially deform the patterned aluminum web 90.

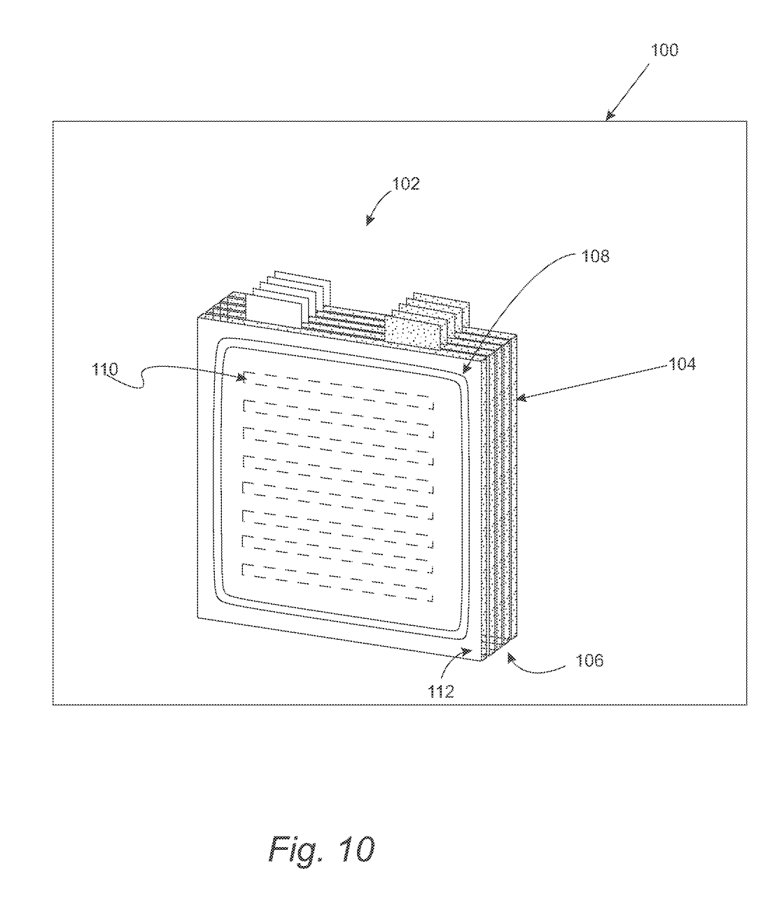

Referring now to FIG. 10, a vehicle 100 is shown with a traction battery 102. The traction battery 102 has a plurality of pouch-type cells 104 that are stacked to form an array 106. Each of the cells 104 includes a thermally conductive pouch 108 with a plurality of topographic features 110 to increase the effective surface area of the cell. A cooling arrangement 112 is interleaved with the cells and configured to direct coolant over and/or around the topographic features to cool the battery.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A pouch-type battery cell comprising:
at least one cell electrode having a cell side;
a thermally conductive pouch contacting the cell side and including a metal layer having a plurality of topographic features formed therein configured to increase an effective surface area of the pouch; and
a cover arrangement configured to direct coolant over the pouch.

2. The pouch-type battery cell of claim 1, wherein the topographic features are channels having an elongated shape.

3. The pouch-type battery cell of claim 1, wherein the topographic features have a wavy shape.

4. The pouch-type battery cell of claim 1, wherein the topographic features comprise a plurality of discrete raised regions.

5. The pouch-type battery cell of claim 1, wherein the topographic features have an arc shape.

6. A pouch-type battery cell comprising:
at least one cell electrode having a cell side including a plurality of topographic features formed thereon configured to increase an effective surface area of the cell side;
a thermally conductive pouch embossed onto the topographic features; and
a cover arrangement configured to direct coolant over the topographic features.

7. The pouch-type battery cell of claim 6, wherein the topographic features are channels having an elongated shape.

8. The pouch-type battery cell of claim 6, wherein the topographic features have a wavy shape.

9. The pouch-type battery cell of claim 6, wherein the topographic features comprise a plurality of discrete raised regions.

10. The pouch-type battery cell of claim 6, wherein the topographic features have an arc shape.

11. A vehicle comprising:
a fraction battery including
a plurality of pouch-type cells stacked to form an array, each of the cells including a thermally conductive pouch having a plurality of topographic features formed therein and configured to increase an effective surface area of the cell, and
a cooling arrangement interleaved with the cells and configured to direct coolant over the topographic features to cool the battery.

12. The vehicle of claim 11, wherein the topographic features are channels having an elongated shape.

13. The vehicle of claim 11, wherein the topographic features have a wavy shape.

14. The vehicle of claim 11, wherein the topographic features comprise a plurality of discrete raised regions.

15. The vehicle of claim 11, wherein the topographic features have an arc shape.
